(19) United States
(12) Patent Application Publication
(10) Pub. No.: US 2023/0144357 A1
(43) Pub. Date: May 11, 2023

(54) TREATMENT EFFECT ESTIMATION USING OBSERVATIONAL AND INTERVENTIONAL SAMPLES

(71) Applicant: ADOBE INC., San Jose, CA (US)

(72) Inventors: Gaurav Sinha, BANGALORE (IN); Aurghya Maiti, Dhakuria (IN)

(21) Appl. No.: 17/520,403

(22) Filed: Nov. 5, 2021

(51) Int. Cl. G06Q 10/06

(52) U.S. Cl. CPC G06Q 10/0637

(57) ABSTRACT

A treatment effect system estimates treatment effects by trading off between observational samples and interventional samples to maintain within a budget while providing high confidence. The treatment effect system determines whether to perform interventions by comparing the cost of interventional samples with metrics regarding the joint probability distribution of treatments and their parents in a first set of observational samples. If it is determined to not perform interventions, the treatment effect for each treatment is determined using an estimator that uses the first set of observational samples independent of a second set of observational samples. If it is determined to perform interventions, each treatment is identified as a reliable or unreliable treatment. The treatment effect for reliable treatments is estimated using an estimator that uses the first set of observational samples split into two portions. The treatment effect for unreliable treatments is estimated using interventional samples generated from interventions.

### BACKGROUND

Estimating the average treatment effect of treatment variables on a desired outcome is one of the main components of prescriptive analysis in the sciences and social sciences. Treatment effect estimation has applications across multiple domains. For instance, application in the medical domain may include estimating the effect of multiple treatments, such as taking preventive-vaccines, immunity-boosters, and food-supplements, on a desired clinical outcome, such as the prevention of a disease. With massive growth in online technologies, some of these treatment effect analyses have also become very crucial in the decision making process in the domain of online businesses. For example, the treatment effect of a new page layout on a click through rate could be estimated. As another example, the treatment effect of a new ranking algorithm on engagement could be estimated.

One conventional approach to estimate treatment effects is to actually perform the respective treatment interventions on randomly chosen sub-populations and empirically estimate the average outcome for the sub-population. However, performing such interventions can be very costly in practice. These costs could be of multiple types, including: (1) enforcing a treatment requires infrastructure changes leading to resource and time costs; and (2) sub-optimal interventions lead to losses in the overall outcome. Another conventional approach estimates treatment effects using historical observational data along with a causal graph capturing causal relationships between the treatment variables, co-variates, and outcome variable. Given these, treatment effects can be estimated, for instance, by simulating interventions on the causal graph using the do( ) operator or equivalently using the backdoor criterion. The main drawback of this conventional approach is that if a treatment does not occur enough number of times in this observational data, confidence on the treatment effect estimation can be very off.

### SUMMARY

Embodiments of the present invention relate to, among other things, a treatment effect system that estimates treatment effects of treatments on an outcome in a manner that performs a trade-off between observational samples and interventional samples to keep cost within a budget while providing treatment effect estimates with high confidence. The treatment effect system uses a first set of observational samples that consumes only a portion of a budget to determine whether to perform interventions. The determination may be made by comparing a cost of interventional samples with metrics based on joint probability distribution of treatments and their parents in a known causal graph calculated using the first set of observational samples. If it is determined to not perform interventions, the treatment effect for each treatment is determined using an estimator based on backdoor criterion that uses the first set of observational samples independent of a second set of observational samples to control bias presented by parent variables. If it is determined to perform interventions, each treatment is identified as either a reliable treatment or an unreliable treatment. The treatment effect for reliable treatments is estimated via an estimator using the first set of observational samples split into two portions to control bias presented by parent variables. The treatment effect for unreliable treatments is estimated using interventional samples generated by performing interventions.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram illustrating an exemplary system in accordance with some implementations of the present disclosure;

FIG. 2 is a flow diagram showing a method for estimating treatment effects for treatments by trading off between observational samples and interventional samples to stay within a budget in accordance with some implementations of the present disclosure;

FIG. 3 is a flow diagram showing a method for determining whether to perform interventions using observational data in accordance with some implementations of the present disclosure;

FIG. 4 is a flow diagram showing a method for estimating treatment effects for reliable and unreliable treatments in accordance with some implementations of the present disclosure;

FIGS. 5A-5C provide comparisons of results for experiments using an implementation of the present disclosure and conventional technologies; and

FIG. 6 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, a “treatment variable” refers to a variable that can be changed from one treatment value to another treatment value to cause an effect on an outcome. A treatment variable can have multiple “treatment values,” with each treatment value for a treatment variable comprising a “treatment.” For instance, a desired outcome could be disease prevention and a treatment variable that impacts that outcome could be administering a vaccine (i.e., the treatments for that treatment variable being administering the vaccine or not administering the vaccine).

A “co-variate” comprises a variable that can cause bias when giving a treatment. For instance, a person's age or gender can be a co-variate that impacts the outcome of disease prevention for the treatment variable of administering a vaccine.

A “causal graph” depicts causal relationships among a set of treatment variables, co-variates, and outcome. Each node in the causal graph represents a treatment variable, co-variate, or outcome. In some instances, the causal graph comprises a directed acyclic graph (DAG). The casual graph may be manually generated using expert knowledge or learned from observational data (e.g., feeding the observational data into known algorithms for learning a causal graph).

As used herein, a “treatment effect” for a treatment represents an extent to which the treatment impacts an outcome. For instance, a treatment effect could be estimated that represents the extent to which administering a vaccine impacts disease prevention.

An “observational sample” comprises data drawn from the joint distribution of variables from historical observed information with varying combinations of treatments, co-variates, and outcomes. For instance, observational samples could be drawn from historical patient information that captures treatments, outcomes, and other information for each patient.

An “interventional sample” comprises data obtained by performing forced treatment inventions, for instance, on randomly chosen sub-populations. For instance, an interventional sample could be obtained by administering a vaccine to a sub-population while withholding the vaccine from another sub-population and recording outcomes and information for the sub-populations.

### Overview

Current treatment effect estimation systems support many applications that require estimating effects of treatments on desired outcomes. Such systems can be used in a real time analytics framework to identify what treatments work and what treatments do not work among a set of treatment alternatives. For instance, such systems could be employed to identify effective treatment alternatives for improved clinical outcomes of patients in the medical domain.

Conventional systems for estimating treatment effects present a number of drawbacks as described below:

Randomized Interventions: Under one conventional approach, treatment effects can be estimated by forcibly performing treatment interventions. Producing reliable results using this approach can be very costly due to the need to perform actual treatment interventions. To control cost, a budget B can be employed, that limits the number of treatment interventions to keep cost within the budget. However, since there is an upper cap B on the total budget and this approach only utilizes interventional samples, only

$$\frac{B}{2 n γ} ,$$

many samples can be used for each individual treatment Tᵢ=t, i∈{1, . . . , n}, t∈{0,1}. This limits the number of interventional samples for each estimation leading to bad confidence guarantees on the estimates. Moreover, this technique completely ignores the side information provided by the causal structure. This is the usual technique deployed while running A/B/n tests that compare multiple treatments to choose the best one. This approach will be referred to herein as Uniform Exploration.

Do Calculus/Backdoor Criterion: Another conventional approach uses observational samples only to estimate treatment effects. This approach estimates conditional probability distributions P(V|Pa(V)) for all nodes V∈ [symbol] ∪ [symbol] where Pa(V) denotes the parents of V in a causal graph G, using observational samples from the joint distribution of [symbol] ∪ [symbol] {Y}. The causal bayesian network thereby obtained (i.e. the graph and all conditional probabilities) is then subjected to the do( ) operator in order to estimate treatment effects of treatments. The treatment effect for Tᵢ=t, then is simply the expected outcome value in the network obtained as a result of do (Tᵢ=t). An equivalent method is to use the backdoor criterion. This conventional approach will be referred to herein as OBS-ALG. A shortcoming of this conventional approach is that some of the parent variables can contain settings which appear with low probability. As a result, these settings may not be seen enough in the B samples leading to bad estimates of the conditional probability distributions which eventually leads to bad treatment effect estimates.

Causal Bandits: Some more recent approaches use the causal graph and trade off between observations and interventions in order to find the best treatment intervention. However, these approaches are greatly limited in application. Some approaches consider the non-budgeted problem only and do not assume any cost on the interventions. Other approaches consider the budgeted version with strong assumptions of no backdoor paths in the causal graphs. Additionally, these approaches are designed to find a best treatment as opposed to estimating the treatment effect of each treatment.

Embodiments of the present invention solve these problems by providing a treatment effect system that estimates treatment effects of treatments on an outcome using an approach that trades off between observational samples and interventional samples in a manner that stays within a budget (thereby limiting cost) while also providing high confidence treatment effect estimates.

In accordance with some aspects of the technology described herein, input to the treatment effect system may include, among other things, a causal graph, a budget, a cost for interventional samples, and observational samples. A first set of observational samples whose total cost only consumes a portion of the budget are initially drawn. This first set of observational samples are then used to determine whether to draw more observational samples or perform interventions. In accordance with some aspects, the determination is made by comparing the cost of interventional samples with metrics regarding the joint probability distribution of treatments and their parents in the first set of observational samples, including: (1) a causal parameter based on a skewness of the joint probability distribution of treatments and their parents in the causal graph; and (2) a minimum value of the joint probability distribution.

If it is determined to use more observational samples, a second set of observational samples is drawn to consume the remainder of the budget. The treatment effects of treatments are estimated using an estimator based on the backdoor criterion but that maintains the first set of observational samples independent from the second set of observational samples to ensure that the estimator is unbiased.

If it is determined to perform interventions, each treatment is identified as being a reliable treatment or an unreliable treatment based on a comparison of the causal parameter for the treatment and the minimum value of the joint probability distribution of the treatment and its parents in the causal graph. Each of the causal parameter and minimum value are determined using the first set of observational samples. For reliable treatments, the treatment effect is estimated using an estimator based on the backdoor criterion in which the first set of observational samples is divided into two portions and the estimator maintains the two portions independent from one another to ensure that the estimator is unbiased. For unreliable treatments, interventions are performed for each unreliable treatment, and the treatment effect of each unreliable treatment is estimated based on the interventions for the unreliable treatment. The number of interventions performed is based on the cost of the interventions such that total cost of the interventions consumes no more than the portion of budget remaining after the total cost associated with the first set of observational samples. This ensures that the process remains within the overall budget.

The technology described herein provides a number of advantages over conventional treatment effect estimation approaches. In contrast to use of interventional samples only, the technology described herein uses a budget to minimize costs. In contrast to use of observational samples only, the technology described herein can identify situations in which interventions improve the reliability of the treatment effect estimates while remaining in budget. As a result, the technology described herein is able to minimize the cost of performing treatment interventions while also ensuring good confidence on the treatment effect estimates. In contrast to more recent approaches, the technology described herein incorporates the budgeted scenario (with a cost of interventions), is not limited by any assumption on the causal graph structure (i.e., it can address backdoor paths in the causal graph), and can estimate treatment effects for all treatments, as opposed to finding a best treatment intervention.

### Example System for Treatment Effect Estimation

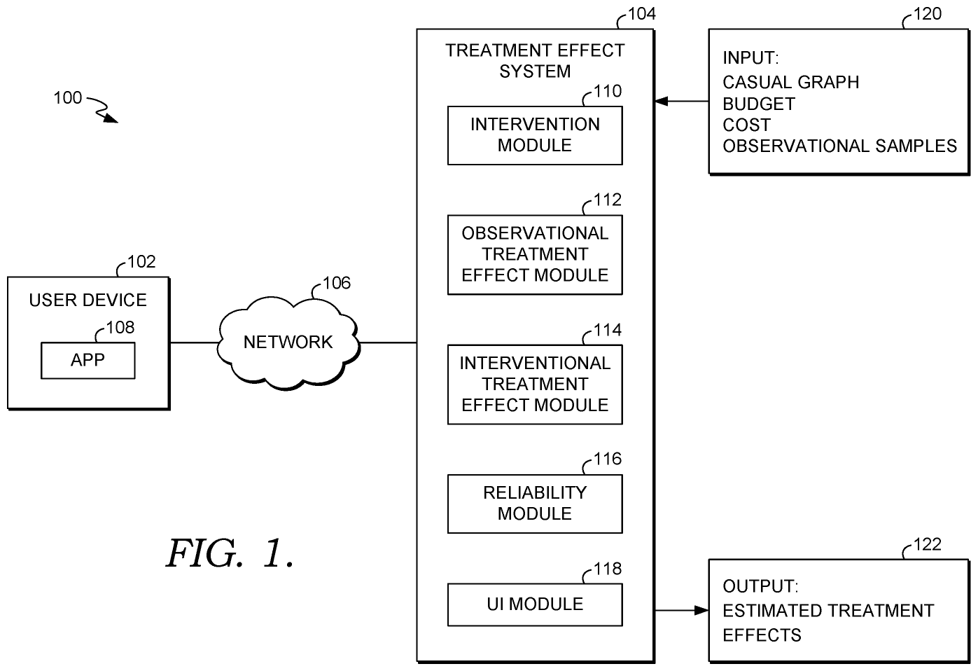

With reference now to the drawings, FIG. 1 is a block diagram illustrating an exemplary system 100 for estimating treatment effects of treatments on outcomes by selecting between the use of observational samples and interventional samples in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

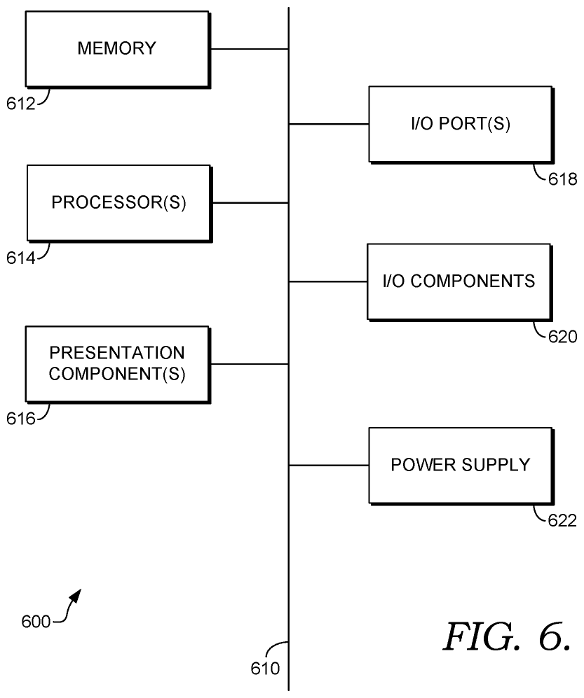

The system 100 is an example of a suitable architecture for implementing certain aspects of the present disclosure. Among other components not shown, the system 100 includes a user device 102 and a treatment effect system 104. Each of the user device 102 and treatment system 104 shown in FIG. 1 can comprise one or more computer devices, such as the computing device 600 of FIG. 6, discussed below. As shown in FIG. 1, the user device 102 and the treatment effect system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present invention. Each may comprise a single device or multiple devices cooperating in a distributed environment. For instance, the treatment effect system 104 could be provided by multiple server devices collectively providing the functionality of the treatment effect system 104 as described herein. Additionally, other components not shown may also be included within the network environment.

At a high level, the treatment effect system 104 estimates treatment effects 122 of treatments on outcomes by trading off between observational samples and interventional samples. As shown in FIG. 1, the treatment effect system 104 includes an intervention module 110, an observational treatment effect module 112, an interventional treatment effect module 114, a reliability module 116, and a user interface (UI) module 118. These components may be in addition to other components that provide further additional functions beyond the features described herein.

The treatment effect system 104 can be implemented using one or more server devices, one or more platforms with corresponding application programming interfaces, cloud infrastructure, and the like. While the treatment effect system 104 is shown separate from the user device 102 in the configuration of FIG. 1, it should be understood that in other configurations, some or all of the functions of the treatment effect system 104 can be provided on the user device 102.

As shown in FIG. 1, the treatment effect system 104 operates on a set of inputs 120 to provide estimated treatment effects 122 for treatments on an outcome. The set of inputs 120 may include, for instance, a causal graph showing causal relationships among treatments, co-variates, and outcomes. Additionally, the set of inputs 120 may include a budget of B units for the overall treatment effect estimation process. The set of inputs may also specify a cost for interventional samples γ (as well as a cost for observational samples, which may otherwise default to one). Typically, the cost for interventional samples is greater than the cost for observational samples to account for the cost to perform interventions. The set of inputs may further include observational samples available for use in the treatment effect estimation process.

The treatment effect system 104 uses the inputs to implement an overall algorithm (referred to herein as ATE-ALG) for the estimation of the effects of each treatment [symbol] =t, i∈{1, . . . , n} and t∈{0,1}. For purposes of discussion herein, let [symbol] ={T₁, . . . Tₙ} be a set of treatment variables, [symbol] ={X₁, . . . , Xₘ} be a set of co-variates, and Y be the outcome variable. For simplicity, each treatment variable may be considered herein to be binary (i.e., two treatments for each treatment variable); however, in some configurations, the treatment effect system can consider treatment variables having more than two associated treatments. Assume that G is a known causal graph (e.g. a Directed Acyclic Graph (DAG)) on nodes [symbol] ∪ [symbol] ∪{Y} that captures the underlying causal structure between these variables. For simplicity, the discussion herein may consider the cost of an observational sample from the true joint distribution of [symbol] ∪ [symbol] ∪{Y} to be one unit, and that of an interventional sample to be γ units. However, the cost of observational samples can be considered to be a different number of units in some embodiments. Additionally, while the cost of samples (observational or interventional), can be considered to be same for all treatment, Tᵢ=t with i∈{1, . . . , n} and t∈{0,1}, in some configurations, different costs may be assigned to different treatments. Given an overall budget of B units, the goal is to optimally draw observational and interventional samples to obtain high confidence estimates \hat{μ}_{i,t} of the treatment effects [symbol] [Y|do(Tᵢ=t)], i∈{1, . . . , n}, t∈{0,1}.

The treatment effects estimated by this algorithm can be evaluated based on the maximum error made on an estimation, that is

$$ϵ = {max}_{i , t} {max}_{y} \vert {\hat{μ}}_{i , t} ( y ) - {μ}_{i , t} ( y ) \vert \qquad ( 1 )$$

where \hat{μ}_{i,t}(y) is a pointwise estimate for the true treatment effect μ_{i,t}(y)= [symbol] [Y=y|do(Tᵢ=t)]. The algorithm is implemented via several modules shown in FIG. 1 as will be described in further detail below.

The intervention module 110 uses a first set of observational samples (e.g., from the observational samples provided as part of the inputs 120) to determine whether to use observational samples only to estimate treatment effects for each treatment or to have interventions performed for some treatments in order to use interventional samples to estimate treatment effects for those treatments. The number of observational samples to include in the first set is such that the total cost of the first set of observational samples consumes only a portion (e.g., a half) of the budget. For instance, in the case that the cost of an observational sample is one unit and given an overall budget of B units, the first set of observational samples may include B/2 observational samples.

The invention module 110 uses inequality 2 below to determine whether to use observational sample only to estimate treatment effects or to also use interventional samples. This is done by checking if inequality 2 is true. The inequality involves a causal parameter m, which captures the skewness of the joint probability distribution of a treatment and its parents (in the causal graph), i.e. [symbol] (Tᵢ=t, Pa(Tᵢ)). For the formal definition of causal parameter m, let q_{i,t}=min_{z} [symbol] (Tᵢ=t, Pa(Tᵢ)=z) be the minimum value of the joint probability distribution. For each τ∈{2, . . . , n} Iᵣ={(i,t): q_{i,t}<1/τ} is defined to be the set of interventions that are τ skewed, and the causal parameter m is defined as m=min{|I_{τ}|≤τ}.

Using the first set of observational samples (e.g., B/2 observational samples), the estimates \hat{q}_{i,t} of q_{i,t} and \hat{m} of m are computed. Given these estimates, inequality 2 below is used to test whether to use interventional samples for estimating the treatment effects of at least some treatments.

$$γ > \frac{1}{\hat{m} \cdot {min}_{i , t} {\hat{q}}_{i , t}} \qquad ( 2 )$$

If Inequality 2 is true: The observational treatment effect module 112 estimates the treatment effect of each treatment using observational samples. In particular, a second set of observational samples is obtained and used in conjunction with the first set of observational samples by the observational treatment effect module 112 to estimate the treatment effect for each treatment. The number of observational samples in the second set is such the total cost of the second set uses the budget remaining after the cost of the first set of observational samples. For instance, if the first set of observational samples comprises B/2 samples, the second set may include B/2 more observational samples. Using the B samples from the two sets, for each i∈{1, . . . , n} and t∈{0,1}, an estimator of the treatment effect based on the backdoor criterion (shown below as equation 3) is used by the observational treatment effect module 112 to estimate the treatment effect for each treatment using the observational samples {(Y(j),Tᵢ(j),Pa(Tᵢ)(j)):j∈{1, . . . , B}}:

$${\hat{μ}}_{i , t} = {\sum }_{z} [ \frac{{\sum }_{j = 1}^{B / 2} 𝟙 \{ Pa ( {T}_{i} ) ( j ) = z \}}{B / 2} ] [ \frac{{\sum }_{j = B / 2 + 1}^{B} 𝟙 \{ Y ( j ) = 1 , {T}_{i} ( j ) = t , Pa ( {T}_{i} ) ( j ) = z \}}{{\sum }_{j = B / 2 + 1}^{B} 𝟙 \{ {T}_{i} ( j ) = t , Pa ( {T}_{i} ) ( j ) = z \}} ] \qquad ( 3 )$$

where the outer summation is over all values z of the parent set [symbol] Tᵢ). There are two internal summations. The first internal summation estimates [symbol] ( [symbol] (Tᵢ)= [symbol] ) using the first set of observation samples, e.g., j=1, . . . , B/2. The second internal summation estimates [symbol] (Y|Tᵢ=t, Pa(Tᵢ)=z) using the second set of observational samples,

$$j = \frac{B}{2} + 1 , … , B .$$

Since disjoint samples are used in both parts, the two parts are independent and taking expectation on both sides proves that the estimator is unbiased.

$$𝔼 [ {μ}_{i , t} ] = {\sum }_{z} ℙ ( Pa ( {T}_{i} ) = 𝓏 ) ℙ ( Y \vert {T}_{i} = t , \\ Pa ( {T}_{i} ) = 𝓏 ) = {μ}_{i , t} \qquad ( 4 )$$

Note that the second equality above holds because of the backdoor criterion since Pa(Tᵢ) block all backdoor paths from Tᵢ to Y. In other words, the parent variables of a treatment are seen as backdoor variables that can have a biasing effect, and maintaining the two sets of observational samples as separate ensures that the estimator is not biasing over the parent variables.

If inequality 2 is false: In this case, the budget remaining after the cost of the first set of observational sample (e.g., B/2) is used to perform interventions. However, interventions are not necessarily performed for all treatments. There are some treatments whose effect can already be well estimated using the first set of observational samples. These treatments are referred to herein as reliable treatments, and the remaining treatments are referred to as unreliable treatments. Using the following definitions for reliable/unreliable treatment, the reliability module 116 determines whether each treatment is reliable or unreliable based on the first set of observational samples:
Tᵢ=t is reliable if \hat{q}_{i,t}≥1/\hat{m}, and
Tᵢ=t is unreliable if \hat{q}_{i,t}<1/\hat{m}

For each treatment identified as reliable by the reliability module 116, the observational treatment effect module 112 estimates the treatment effect using the first set of samples. In the case in which the first set includes B/2 observational samples, the observational treatment effect module 112 estimates the treatment effect using an estimator similar to the one given in equation 3 above (with the first set of observational samples split between the two internal summations), as represented below:

$${\hat{μ}}_{i , t} = {\sum }_{z} [ \frac{{\sum }_{j = 1}^{B / 4} 𝟙 \{ Pa ( {T}_{i} ) ( j ) = z \}}{B / 4} ] [ \frac{{\sum }_{j = B / 4 + 1}^{B / 2} 𝟙 \{ Y ( j ) = 1 , {T}_{i} ( j ) = t , Pa ( {T}_{i} ) ( j ) = z \}}{{\sum }_{j = B / 4 + 1}^{B / 2} 𝟙 \{ {T}_{i} ( j ) = t , Pa ( {T}_{i} ) ( j ) = z \}} ] \qquad ( 5 )$$

As described earlier, this provides unbiased estimators of the treatment effects for the reliable treatments.

Interventions are performed to obtain interventional samples for each of the treatments identified as unreliable. As noted above, the remaining portion of the budget after the cost of the first set of observational samples is used to perform interventions based on the number of unreliable treatments and the cost to perform interventions for each unreliable treatment. In some cases, the number of interventions may vary among the unreliable treatments, while in other cases, the number of interventions is the same for the unreliable treatments. For instance, given M as the number of unreliable treatments, for each of these unreliable treatments

$$( say {T}_{i} = t ) , \frac{B}{2 γ M}$$

actual interventions are performed.

The interventional treatment effect module 114 estimates the treatment effect for each unreliable treatment using interventional samples generated from the interventions. For instance, the interventional treatment effect module 114 may use empirical mean of the outcomes

$$\{ Y ( j ) : j ∈ \{ 1 , … , \frac{B}{2 γ M} \} \}$$

to compute the treatment effect estimates, as follows:

$${\hat{μ}}_{i , t} = \frac{2 γ M}{B} {\sum }_{j = 1}^{B / ( 2 γ M )} Y ( j )$$

The user interface (UI) module 118 of the treatment effect system 104 provides a user interface for interacting with the treatment effect system. For instance, the UI module 118 can provide user interfaces for receiving input, such as the input 120, and providing output, such as the output 122. For instance, the UI module 118 can provide a UI to a user device, such as the user device 102. The user device 102 can be any type of computing device, such as, for instance, a personal computer (PC), tablet computer, desktop computer, mobile device, or any other suitable device having one or more processors. As shown in FIG. 1, the user device 102 includes an application 108 for interacting with the visual search system 104. The application 108 can be, for instance, a web browser or a dedicated application for providing visual search functions, such as those described herein. The application 108 can present the UI provided by the UI module 118.

### Example Methods for Treatment Effect Estimation

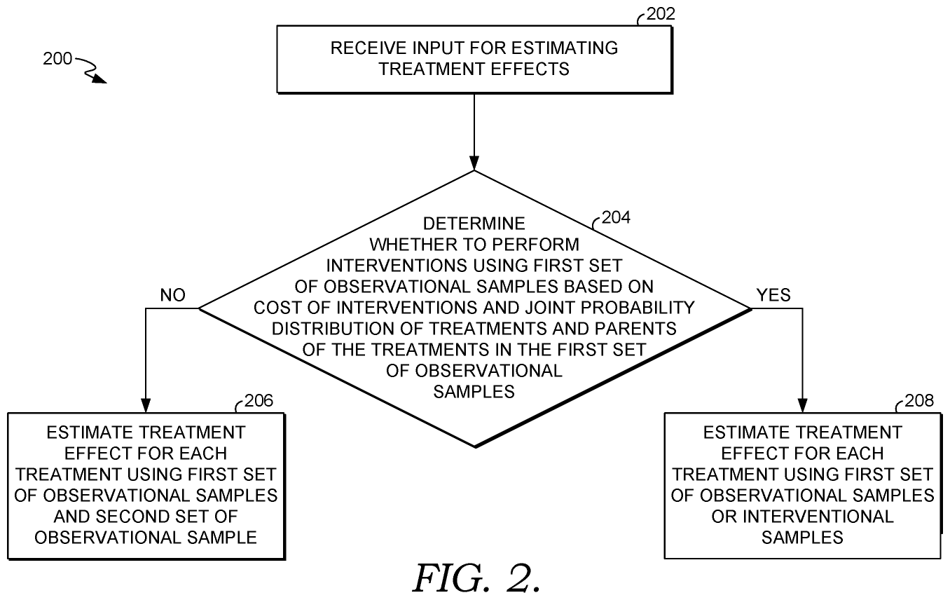

With reference now to FIG. 2, a flow diagram is provided that illustrates a method 200 for estimating treatment effects of treatments on an outcome. The method 200 may be performed, for instance, by the treatment effect system 104 of FIG. 1. Each block of the method 200 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 202, input for estimating the treatment effect of treatments on an outcome are received. The input may include, for instance, a causal graph showing causal relationships among treatments, co-variates, and outcomes. Additionally, a budget for the overall treatment effect estimation process may be provided. A cost of interventional samples may also be input, as well as observational samples for use in estimating treatment effects.

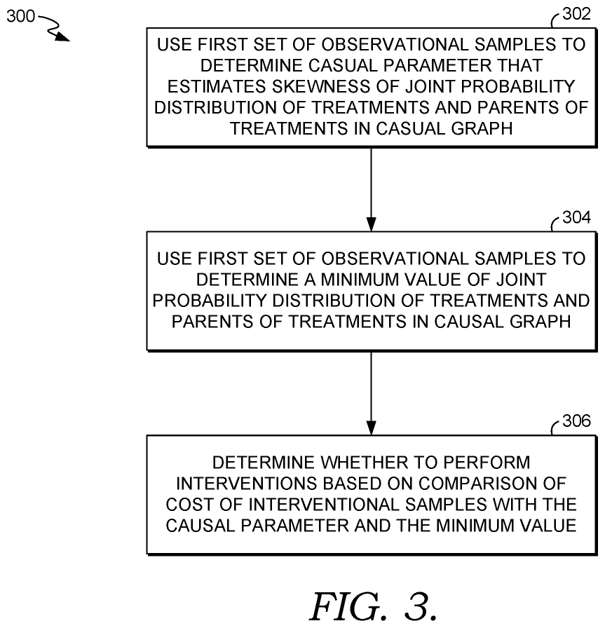

Using a first set of observational samples, a determination is made regarding whether to perform interventions, as shown at block 204. FIG. 3 provides a flow diagram showing one method 300 for making this determination. The method 300 may be performed, for instance, by the intervention module 110 of FIG. 1. As shown at block 302, the first set of observational samples are used to determine a causal parameter that estimates skewness of a joint probability distribution of treatments and their parents in the causal graph, as discussed above for the intervention module 110 of FIG. 1. Additionally, as shown at block 304, the first set of observational samples are used to determine a minimum value of the joint probability distribution of treatments and parents of the treatments in the causal graph, as discussed above for the intervention module 110 of FIG. 1. A determination regarding whether to perform interventions and use interventional samples to estimate treatment effects is made at block 306 based on a comparison of the cost of interventional samples with the causal parameter determined at block 302 and the minimum value determined at block 304. This determination at block 306 may be made using inequality 2 discussed hereinabove.

Returning to FIG. 2, if it is determined that interventional samples will not be used, the treatment effect for each treatment is estimated using observational samples, as shown at block 206. The treatment effect for each treatment may be estimated, for instance, using the observational treatment effect module 112 of FIG. 1. In some instances, the treatment effect for each treatment can be estimated using the first set of observational samples and a second set of observational samples, for instance, using equation 3 discussed hereinabove. As noted, this ensures the estimator is unbiased.

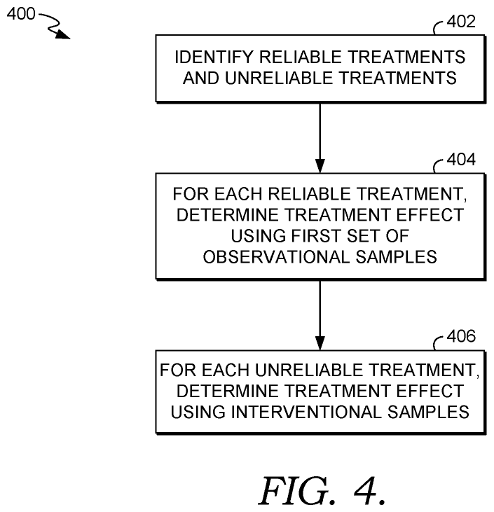

Alternatively, if it is determined that interventional samples will be used, the treatment effect for each reliable treatment is estimated using the first set of observational samples and the treatment effect for each unreliable treatment is estimated using interventional samples. FIG. 4 provides a flow diagram showing a method 400 for estimating treatment effects for reliable and unreliable treatments. As shown at block 402, each treatment is determined to be a reliable treatment or an unreliable treatment. This determination may be made, for instance, using the reliability module 116 of FIG. 1, as described hereinabove.

As shown at block 404, the treatment effect for each reliable treatment is estimated using the first set of observational samples. This estimation may be performed by the observational treatment effect module 112 of FIG. 1 using, for instance, equation 5 in which the first set of observational samples is separated into two portions to control bias. As shown at block 406, the treatment effect for each unreliable treatment is estimated using interventional samples obtained by performing interventions. This estimation may be performed by the interventional treatment effect module 114 of FIG. 1, as described hereinabove.

### Performance Evaluation

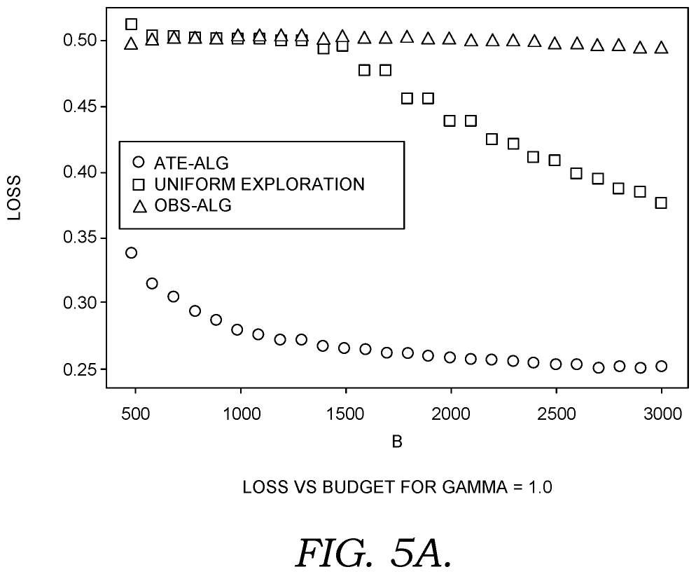

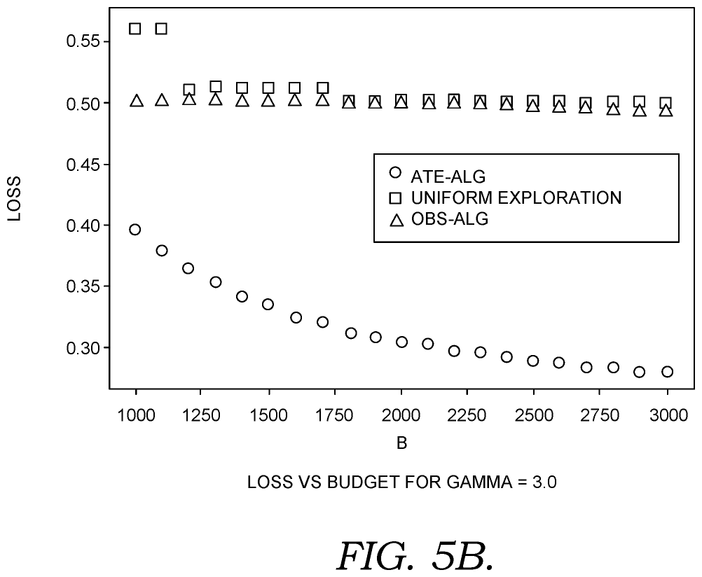

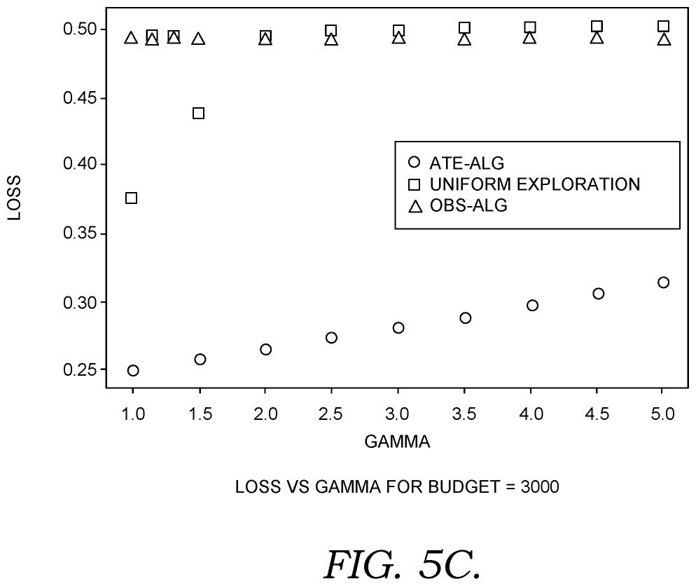

The performance of the treatment effect system using the technology described herein (ATE-ALG) was compared against the performance of two conventional approaches, a pure observational algorithm (OBS-ALG) and a pure interventional algorithm (Uniform Exploration). Experiments were run using synthetically-created data for the purposes of assessing performance of the different approaches. Loss was accessed for the experiments using equation 1 discussed hereinabove. Comparisons of the results are shown in FIGS. 5A-5C.

Loss vs Budget: FIG. 5A and FIG. 5B are graphs showing results from experiments comparing the loss of the three approaches (ATE-ALG (technology described herein), OBS-ALG, and Uniform Exploration) as the budget B increases. The three approaches were run on 60 randomly generated Causal Bayesian Networks (CBN) such that for every CBN, the number of treatments which have low probability of occurrence is 20. The CBNs were constructed as follows: a) randomly generated 60 DAGs with 101 nodes X₁, . . . , X₁₀₀ and Y, and let X₁ [symbol] . . . [symbol] X₁₀₀ [symbol] Y be the topological order in each such DAG; b) Pa(Xᵢ) contains at most 2 nodes chosen uniformly at random from X₁, . . . , Xᵢ₋₁, and Pa(Y) contains Xᵢ for all i; c) [symbol] (Xᵢ|Pa(Xᵢ))=0.5 for i∈[80] and [symbol] (Xᵢ|Pa(Xᵢ))= 1/400 for i∈[81,100]; d) uniformly at random chose a j∈{92, . . . , 100} and set P(Y|X₁, . . . , Xⱼ=1, . . . , X₁₀₀)=0.5+ϵ and P(Y|X₁, . . . , Xⱼ=0, . . . , X₁₀₀)=0.5−ϵ′ where ϵ=0.3 and ϵ′=qϵ/(1−q) for q= 1/200. For each of the 60 random CBNs, the three approaches were run for multiple values of the budget B∈[1000,3000] and then loss was averaged over 100 independent runs. Finally, the mean loss over all the random CBNs and independent runs were calculated to compare the results. As shown in FIGS. 5A and 5B, the technology described herein (ATE-ALG) clearly outperforms the other approaches (OBS-ALG and Uniform Exploration) for two different values of γ (1.0 and 3.0, respectively).

Loss vs Cost: FIG. 5C is a graph showing the results from an experiment in which the budget is fixed at B=3000, and the cost of intervention γ is varied from 1 to 5. In this case also, 60 random CBNs were generated as mentioned above, and the loss of the three approaches were determined. A comparison the results for the three approaches are shown in FIG. 5C. Again, much better loss was observed for the approach using the technology described herein (ATE-ALG) compared to the prior approaches (OBS-ALG and Uniform Exploration) when γ increases.

### Exemplary Operating Environment

Having described implementations of the present disclosure, an exemplary operating environment in which embodiments of the present invention may be implemented is described below in order to provide a general context for various aspects of the present disclosure. Referring initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes bus 610 that directly or indirectly couples the following devices: memory 612, one or more processors 614, one or more presentation components 616, input/output (I/O) ports 618, input/output components 620, and illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 600. The computing device 600 may be equipped with depth cameras, such as, stereoscopic camera systems, infrared camera systems, RGB camera systems, and combinations of these for gesture detection and recognition. Additionally, the computing device 600 may be equipped with accelerometers or gyroscopes that enable detection of motion.

The present invention has been described in relation to particular embodiments, which are intended in all respects to be illustrative rather than restrictive. Alternative embodiments will become apparent to those of ordinary skill in the art to which the present invention pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by a computing device, cause the computing device to perform operations, the operations comprising:
using a first set of observational samples to determine: (1) a causal parameter that estimates skewness of a joint probability distribution of treatments and parents of the treatments in a causal graph, and (2) a minimum value of the joint probability distribution of the treatments and the parents of the treatments in the causal graph;
determining whether to perform interventions based on a comparison of a cost of interventional samples with the causal parameter and the minimum value;
based on a determination to not perform interventions, estimating a treatment effect for each treatment in the causal graph using the first set of observational samples and a second set of observational samples; and
based on a determination to perform interventions:
identifying each treatment in the causal graph as either a reliable treatment or an unreliable treatment,
estimating a treatment effect for each reliable treatment using the first set of observational samples, and
estimating a treatment effect for each unreliable treatment using data collected from one or more interventions performed for each unreliable treatment.

2. The computer storage media of claim 1, wherein a number of observational samples in the first set of observational samples is determined based on a budget and a cost assigned to each observational sample, wherein a total cost of the first set of observational samples is less than the budget.

3. The computer storage media of claim 2, wherein a number of observational samples in the second set of observational samples is determined based on a difference between the budget and the total cost of the first set of observational samples.

4. The computer storage media of claim 2, wherein a number of interventions is determined based on the budget, a cost associated with the interventional samples, and the total cost of the first set of observational samples.

5. The computer storage media of claim 1, wherein when the determination is to not perform interventions, the treatment effect for a first treatment is estimated based on: (1) a first summation that estimates a probability of values of parents of the first treatment using the first set of observational samples, and (2) a second summation that estimates a probability of an outcome given the first treatment and parents of the first treatment using the second set of observational samples.

6. The computer storage media of claim 1, wherein when the determination is to perform interventions, a first treatment in the causal graph is identified as either a reliable treatment or an unreliable treatment based on a comparison of: (1) a first causal parameter for the first treatment that estimates skewness of a joint probability distribution of the first treatment and parents of the first treatment in the causal graph, with (2) a first minimum value of the joint probability distribution of the first treatment and the parents of the first treatment in the causal graph.

7. The computer storage media of claim 1, wherein when the determination is to perform interventions, the treatment effect for a first reliable treatment is estimated based on: (1) a first summation that estimates a probability of values of parents of the first reliable treatment using a first portion of the first set of observational samples, and (2) a second summation that estimates a probability of an outcome given the first reliable treatment and parents of the first reliable treatment using a second portion of the first set of observational samples.

8. The computer storage media of claim 1, wherein when the determination is to perform interventions, the treatment effect for a first unreliable treatment is estimated using an empirical means of outcomes for a set of interventional samples from interventions for the first unreliable treatment.

9. A computerized method comprising:
determining, by an intervention module using a first set of observational samples, whether to use observational samples or use a combination of observational samples and interventional samples to estimate treatment effects for treatments in a causal graph;
based on a determination to use observational samples to estimate treatment effects, estimating, using an observational treatment effect module, a treatment effect for each treatment in the causal graph using the first set of observational samples and a second set of observational samples; and
based on a determination to use a combination of observational samples and interventional samples to estimate treatment effects:
identifying, by a reliability module using the first set of observational samples, each treatment in the causal graph as either a reliable treatment or an unreliable treatment,
estimating, by the observational treatment effect module, a treatment effect for each reliable treatment using the first set of observational samples, and
estimating, by an interventional treatment effect module, a treatment effect for each unreliable treatment using one or more interventional samples generated based on one or more interventions performed for each unreliable treatment.

10. The computerized method of claim 9, wherein a number of observational samples in the first set of observational samples is determined based on a budget and a cost assigned to each observational sample, wherein a total cost of the first set of observational samples is less than the budget.

11. The computerized method of claim 10, wherein a number of observational samples in the second set of observational samples is determined based on a difference between the budget and the total cost of the first set of observational samples.

12. The computerized method of claim 10, wherein a number of intervention samples to use by the interventional treatment effect module is determined based on the budget, a cost associated with the interventional samples, and the total cost of the first set of observational samples.

13. The computerized method of claim 9, wherein when the determination is to use observational samples to estimate treatment effects, the observational treatment effect module estimates the treatment effect for a first treatment based on: (1) a first summation that estimates a probability of values of parents of the first treatment using the first set of observational samples, and (2) a second summation that estimates a probability of an outcome given the first treatment and parents of the first treatment using the second set of observational samples.

14. The computerized method of claim 9, wherein when the determination is to use a combination of observational samples and interventional samples to estimate treatment effects, the reliability module identifies a first treatment in the causal graph as either a reliable treatment or an unreliable treatment based on a comparison of: (1) a first causal parameter for the first treatment that estimates skewness of a joint probability distribution of the first treatment and parents of the first treatment in the causal graph, with (2) a first minimum value of the joint probability distribution of the first treatment and the parents of the first treatment in the causal graph.

15. The computerized method of claim 9, wherein when the determination is to use a combination of observational samples and interventional samples to estimate treatment effects, the observational treatment effect module estimates the treatment effect for a first reliable treatment based on: (1) a first summation that estimates a probability of values of parents of the first reliable treatment using a first portion of the first set of observational samples, and (2) a second summation that estimates a probability of an outcome given the first reliable treatment and parents of the first reliable treatment using a second portion of the first set of observational samples.

16. The computerized method of claim 9, wherein when the determination is to use a combination of observational samples and interventional samples to estimate treatment effects, the interventional treatment effect module estimates the treatment effect for a first unreliable treatment using an empirical means of outcomes for a set of interventional samples performed for the first unreliable treatment.

17. A computer system comprising:
a processor; and
a computer storage medium storing computer-useable instructions that, when used by the processor, causes the computer system to perform operations comprising:
identifying, by a reliability module using a set of observational samples, whether each treatment from a causal graph is a reliable treatment or an unreliable treatment based on a comparison of: (1) a causal parameter for each treatment that estimates skewness of a joint probability distribution of each treatment and parents of each treatment in the causal graph, and (2) a minimum value of the joint probability distribution of each treatment and the parents of each treatment in the causal graph;
estimating, by an observational treatment effect module, a treatment effect for each reliable treatment based on the set of observational samples;
estimating, by an interventional treatment effect module, a treatment effect for each unreliable treatment based on a set of interventional samples.

18. The computer system of claim 17, wherein a total cost from summing a cost of the set of observational samples and a cost of the set of interventional samples does not exceed a budget.

19. The computer system of claim 17, wherein the observational treatment effect module estimates the treatment effect for a first reliable treatment based on: (1) a first summation that estimates a probability of values of parents of the first reliable treatment using a first portion of the set of observational samples, and (2) a second summation that estimates a probability of an outcome given the first reliable treatment and parents of the first reliable treatment using a second portion of the set of observational samples.

20. The computer system of claim 17, wherein the interventional treatment effect module estimates the treatment effect for a first unreliable treatment using an empirical means of outcomes for a set of interventional samples performed for the first unreliable treatment.
